(19) United States
(12) Patent Application Publication
(10) Pub. No.: US 2022/0293919 A1
(43) Pub. Date: Sep. 15, 2022

(54) TWO-DIMENSIONAL (2D) TRANSITION METAL DICHALCOGENIDE (TMD) MATERIAL-COATED ANODE FOR IMPROED METAL ION RECHARGEABLE BATTERIES

(71) Applicant: University of North Texas, Denton, TX (US)

(72) Inventors: Wonbong Choi, Coppell, TX (US); Sanket Bhoyate, Denton, TX (US)

(21) Appl. No.: 17/689,974

(22) Filed: Mar. 8, 2022

Related U.S. Application Data
(60) Provisional application No. 63/158,856, filed on Mar. 9, 2021.

(51) Int. Cl. H01M 4/36; H01M 4/04; H01M 10/36; C23C 18/54; H01M 4/60; H01M 4/50

(52) U.S. Cl. CPC H01M 4/366; H01M 4/0452; H01M 10/36; C23C 18/54; H01M 4/60; H01M 4/50; H01M 2004/027

(57) ABSTRACT

The present disclosure describes a metal-ion rechargeable battery that includes a metal (such as zinc, aluminum, potassium, sodium, lithium, or lithium-alloys) anode coated with at least one layer of a two-dimensional (2D) transition metal dichalcogenide (TMD) material. The at least one layer of the 2D TMD material, such as molybdenum disulfide (MoS₂), may be deposited on the metal electrode using electrochemical deposition. The battery may also include a carbon material cathode coated with at least one layer of manganese dioxide (MnO₂) or another electrode material. A method of forming such a battery is also described. Batteries that include metal anodes with 2D TMD material coating may have reduced series resistance, exhibit excellent reversible specific capacity, and have stable performance over many cycles with little to no dendrite formation on the metal anodes.

### CROSS-REFERENCE TO RELATED APPLICATIONS

The present application claims the benefit of priority from U.S. Provisional Application No. 63/158,856 filed Mar. 9, 2021 and entitled “TWO-DIMENSIONAL (2D) TRANSITION METAL DICHALCOGENIDE (TMD) MATERIAL-COATED ANODE FOR IMPROVED METAL ION RECHARGEABLE BATTERIES,” the disclosure of which is incorporated by reference herein in its entirety.

### TECHNICAL FIELD

The present disclosure relates generally to electrochemical energy storage systems and methods for manufacturing the same. Specifically, the present disclosure provides for manufacturing and using two-dimensional (2D) transition metal dichalcogenide (TMD) materials to coat metal anodes (such as zinc, potassium, aluminum, sodium, lithium-alloys, and the like) in electrochemical energy storage systems, such as rechargeable metal ion batteries (such as zinc-ion batteries, aluminum-ion batteries, sodium-ion batteries, and the like).

### BACKGROUND

Grid energy storage plays a profound role in stabilizing an inconsistent clean energy supply by acting as an intermediate energy storage and delivery system. Conventional energy storage is dominated by lithium (Li)-ion batteries (LIBs), which may present disadvantages for grid storage applications due to their safety issues, resource scarcity, high cost, and high carbon emissions during production. These issues have prompted research into alternative rechargeable battery systems using earth-abundant materials, such as zinc. One type of battery that is particularly of interest is a zinc (Zn)-ion battery (ZIB) due to its low cost, environmental benignity, and high theoretical capacity. In ZIBs, the Zn²⁺ species produced via contact of a Zn anode in a mild acidic electrolyte is largely responsible for enabling reversible charge-discharge cycles.

Two particular issues have prevented development of ZIBs: stability of cathodes, particularly manganese dioxide (MnO₂) cathodes, and dendrite growth on zinc anodes. A Zn anode in contact with an acidic electrolyte forms Zn²⁺ ions and undergoes an insertion/extraction process with an MnO₂ cathode such that the Zn²⁺ ions reversibly intercalate in the MnO₂ cathode with much stronger electrostatic interaction than that of Li-ions, which causes Jahn-Teller distortion and can significantly decrease the stability of the cathode. Development of suitable cathode materials that compensate for this reduced stability is still in its infancy stage and research continues.

Regarding the stability of the Zn anode, the non-uniform stripping and plating of Zn ions over the anode surface can promote the dendrite growth of Zn during the charging and discharging cycles of the battery, which may eventually cause a short circuit between the anode and the cathode, causing the battery to fail. There have been attempts to mitigate the dendrite growth of the Zn anode by nanostructured material coating. A few examples of such coatings include an ultrathin titanium dioxide (TiO₂) coating using atomic layer deposition, drop casting of nano-porous calcium carbonate (CaCO₃), and modified polyamide coating. Most of the ceramic and polymeric coating materials behave as an insulator by increasing the surface resistance of the anode. Although these materials may prevent dendrite growth, diffusion of Zn-ions through these coating materials is severely restricted and degrades the battery performance. Thus, suppression of Zn dendrite growth while maintaining battery performance remains a challenge.

### SUMMARY

Aspects of the present disclosure provide systems, devices, and methods of manufacturing metal electrodes coated with two-dimensional (2D) transition metal dichalcogenide (TMD) materials (e.g., MoS₂, MoSe₂, WS₂, WSe₂, MoWS₂, MoWTe₂, BN-C, etc.) for use as anodes in metal ion rechargeable batteries, such as zinc-ion batteries, aluminum-ion batteries, sodium-ion batteries, or potassium-ion batteries. For example, a battery may include an anode formed from metals such as zinc (e.g., a zinc anode or zinc metal anode), aluminum, potassium, or the like. One or more layers of a 2D TMD material, such as molybdenum disulfide (MoS₂), may be deposited on the metal by electrochemical deposition to form the anode. The 2D TMD material(s) (e.g., the MoS₂) acts as a protective layer for the anode to reduce dendrite growth on the metal and to provide performance improvements compared to other metal-ion batteries.

In some implementations, the thickness of the layer(s) of the 2D TMD material may be controlled by controlling a deposition time of the electrochemical deposition, preferably such that each layer of 2D TMD material has a thickness of approximately 70 nanometers (nm). The battery of the present disclosure may also include a cathode formed of a carbon material, such as carbon nanotube (CNT) paper, as a non-limiting example. The carbon material may be coated with one of more layers of α-manganese dioxide (α-MnO₂) having nanorod structures. The battery may also include an electrolyte, such as an aqueous electrolyte solution of zinc sulfate (ZnSO₄) and/or manganese sulfate (MnSO₄), that is in contact with the anode and the cathode.

The present disclosure describes systems, devices, and methods of manufacture of electrochemical energy storage devices (e.g., batteries) that provide benefits compared to conventional batteries. For example, a coating of MoS₂ (or another 2D TMD material) on an anode reduces or prevents the formation of dendrites at the anode due to the coating material's high ion transport and uniform deposition properties. Reducing or preventing dendrite growth reduces corrosion of the battery and reduces or prevents safety issues at higher C-rates, as compared to other metal ion batteries. Additionally, the orientation of the coating material improves the flow of metal ions with a uniform electric field distribution on the anode, resulting in uniform stripping and plating of metal ions. In addition, the coating material enhances anodic diffusion of metal ions and reduces the series resistance of the battery, thereby improving the overall battery performance. Further, the electrochemical deposition process used to deposit the coating on the anode is less complex and more scalable than other electrode formation techniques. Thus, the techniques described herein support manufacture of metal-ion rechargeable batteries, such as zinc-ion batteries, aluminum-ion batteries, sodium-ion batteries, potassium-ion batteries, and the like, having a long cycle life, excellent specific capacity, and improved safety, as compared to conventional rechargeable batteries such as lithium ion (Li-ion) batteries or other metal-ion batteries.

In a particular aspect, a method includes providing a metal electrode. The method further includes depositing at least one layer of a two-dimensional (2D) transition metal dichalcogenide (TMD) material on the metal electrode.

In another particular aspect, a battery includes an anode including a metal electrode coated with at least one layer of a two-dimensional (2D) transition metal dichalcogenide (TMD) material. The battery also includes a cathode. The battery further includes an electrolyte in direct contact with the anode and the cathode.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1A illustrates a cross-sectional view of an example of metal electrode according to one or more aspects;

FIG. 1B illustrates aspects of a fabrication process for depositing at least one layer of a two-dimensional (2D) transition metal dichalcogenide (TMD) material on a metal electrode according to one or more aspects;

FIG. 2 illustrates an example of a battery system implemented with a 2D TMD material-coated metal anode according to one or more aspects;

FIG. 3 is a flow diagram illustrating an example of a method for manufacturing a battery with a 2D TMD material-coated metal anode according to one or more aspects;

FIG. 4 depicts an illustrative schematic for fabricating an example of a metal anode having a 2D-TMD material coating according to one or more aspects;

FIGS. 5A-5F illustrate transmission electron microscopy (TEM) images and a Raman mapping of components of the anode of FIG. 4;

FIGS. 6A-6D illustrate results from a symmetric cell test of a battery that includes the anode of FIG. 4;

FIGS. 7A-7F illustrate electrochemical analysis for a bare zinc anode and the anode of FIG. 4;

FIGS. 8A-8C depict illustrative schematics of a battery that include the anode of FIG. 4 during reference, charge, and discharge states;

FIGS. 9A-9C illustrate scanning electron microscopy (SEM) images corresponding to FIGS. 8A-8C;

FIGS. 9D-9F illustrate x-ray photoelectron spectroscopy (XPS) analysis images for a first element of the 2D TMD material coating corresponding to FIGS. 8A-8C; and

FIGS. 9G-9I illustrate XPS analysis images for a second element of the 2D TMD material coating corresponding to FIGS. 8A-8C.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, devices, and methods of manufacturing metal (e.g., zinc, aluminum, sodium, potassium, or the like) electrodes coated with two-dimensional (2D) transition metal dichalcogenide (TMD) materials (e.g., MoS₂, MoSe₂, WS₂, WSe₂, MoWS₂, MoWTe₂, BN-C, etc.) for use as anodes in rechargeable batteries, such as zinc ion (Zn-ion) batteries (ZIBs) or other metal-ion batteries. For example, instead of lithium ion (Li-ion) batteries (LIBs), a battery of the present disclosure may include an anode that includes zinc (or another metal) coated with at least one layer of a 2D TMD material, such as molybdenum disulfide (MoS₂). The 2D TMD material(s) act as a protective layer for the anode to reduce or prevent dendrite grown on the zinc and to provide significant performance improvements as compared to LIBs or other metal-ion batteries.

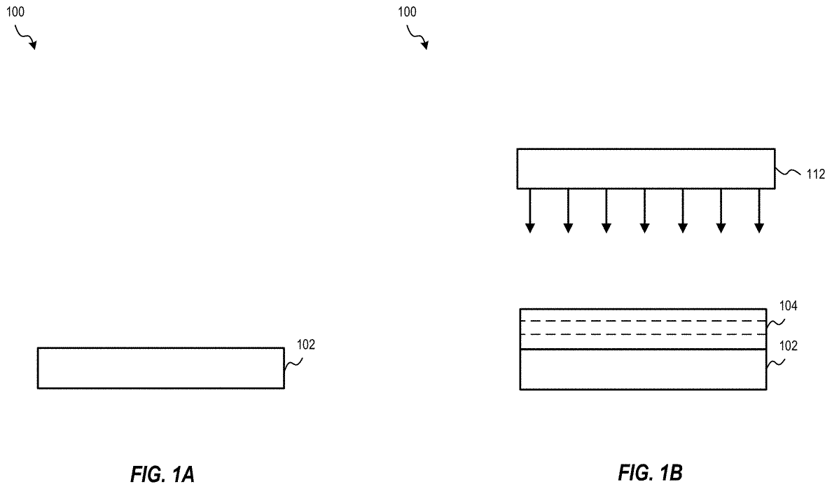

As illustrated by FIGS. 1A-B, methods for fabricating a metal electrode coated with a 2D TMD material are illustrated in accordance with one or more aspects of the present disclosure. Referring to FIG. 1A, before deposition of a 2D TMD material, an electrochemical energy storage system 100 includes an electrode 102. In some implementations, the electrochemical energy storage system 100 is included or integrated in a battery, such as a rechargeable ZIB. The electrode 102 may be any metal electrode (e.g., a substrate of zinc metal or a zinc alloy, or any other metal or metal alloy) with any physical structure. As non-limiting examples, the electrode 102 may include solid zinc metal, porous zinc metal, casted zinc structure, formed zinc structure or additive manufactured zinc sample. In some implementations, the metal of the electrode 102 may include a water-stable metal such as zinc, aluminum, magnesium, or the like. In some other implementations, the metal may include water-unstable metals such as lithium, lithium alloys (e.g., lithium-aluminum, lithium-magnesium, lithium-selenium, lithium-silicon, etc.), sodium, potassium, or the like. Before deposition of additional materials, the electrode 102 may be cleaned, such as with acetic acid, acetone, isopropyl alcohol, deionized water, or the like. In some other implementations, the electrode 102 may be cleaned using a different series of actions, different cleaning solutions, or the electrode 102 may include a treated clean surface, such as a plasma (e.g., argon (Ar), helium (He), hydrogen (H₂), nitrogen gas (N₂ gas), or the like) treated clean surface or a surface that is treated in a vacuum with a functional group (e.g., hydrogen, fluorine, C—H bonding, or the like). The electrode 102 may be configured to operate as an anode (e.g., a negative terminal) for the electrochemical energy storage system 100.

Next, referring to FIG. 1B, 2D TMD material 104 is deposited on the electrode 102 via a deposition system 112. As used herein, 2D TMD materials refer to very thin layer(s) of TMD materials, typically less than 10 nm, preferably 1 nm or less, that have a same crystalline structure as thicker versions of the TMD materials (e.g., bulk forms). To illustrate, 2D TMD materials (e.g., one, or a few, very thin layers of TMD material) produce unusual properties as compared to the TMD materials in their bulk form, such as increased flexibility, larger bandgap, higher optical responsivity, and increased mobility, as non-limiting examples. To further illustrate, the differences in properties between 2D TMD materials and bulk form TMD materials may be similar to the difference in properties between graphite and graphene, even though both graphite and graphene have the same crystalline structure. The 2D TMD material 104 may include one or more layers of a 2D TMD material. As non-limiting examples, the 2D TMD material may include molybdenum disulfide (MoS₂), tungsten disulfide (WS₂), molybdenum ditelluride (MoTe₂), molybdenum diselenide (MoSe₂), tungsten diselenide (WSe₂), titanium disulfide (TiS₂), tantalum disulfide (TaSe₂), niobium diselenide (NbSe₂), nickel ditelluride (NiTe₂), boron nitride (BN), cubic boron nitride (c-BN), hexagonal boron nitride (h-BN), borophene (2D boron), silicene (2D silicon), germanene (2D germanium), composites thereof, or the like, or these compounds (or alloys) combined with one or more additional elements, such as molybdenum tungsten disulfide (MoWS₂), molybdenum tungsten ditelluride (MoWTe₂), molybdenum sulfur ditelluride (MoSTe₂), molybdenum sulfur diselenide (MoSSe₂), molybdenum rhenium disulfide (MoReS₂), niobium tungsten disulfide (NbWS₂), vanadium molybdenum ditelluride (VMoTe₂), tungsten sulfur diselenide (WSSe₂), tungsten tellurium disulfide (WTeS₂), tin selenium disulfide (SnSeS₂), boron carbon nitride (BCN), or the like. It is appreciated that different materials may provide for different performance. In a particular implementation, the 2D TMD material 104 includes MoS₂, because MoS₂ provides strong adhesion to zinc (and other metals); MoS₂ also is readily transformed to a metallic phase to reduce impedance. The 2D TMD material 104 may include a single layer or multiple layers (e.g., a few layers) of 2D TMD material(s). In some implementations, the 2D TMD material 104 may form a single atomic layer on the electrode 102, or each layer of the 2D TMD material 104 may represent a respective atomic layer of material. If the 2D TMD material 104 includes multiple layers, each layer may include the same type of 2D TMD material or at least one layer may be a different type of 2D TMD material than at least one other layer. In some implementations, the 2D TMD material 104 is a structure that is oriented substantially perpendicular from the adjacent surface of the electrode 102 (e.g., vertically oriented, in the orientation shown in FIGS. 1A-B).

In some implementations, one or more layers of the 2D TMD material 104 may have a thickness between approximately (e.g., about) 1 nanometer (nm) and approximately 1000 nm, preferably approximately 70 nm, which may be controlled by controlling a deposition time. As a non-limiting example, the deposition time of the electrochemical deposition performed by deposition system 112 may be varied from 1 to 175 seconds to adjust the thickness of layer(s) of the 2D TMD material 104. In some other implementations, the 2D TMD material 104 may be deposited using other techniques, such as direct current (DC) sputtering, e-beam evaporation, atomic layer deposition, or the like. By coating (or being disposed on) the electrode 102 and preventing direct contact between the electrode 102 and an electrolyte, the 2D TMD material 104 may act as a protective layer for the electrode 102, at least with respect to dendrite growth.

In some implementations, the one or more layers of the 2D TMD material 104 may be deposited through electrochemical deposition using an electroless two, three, or four electrode system (e.g., the deposition system 112). For example, in a three electrode system, the electrode 102 (e.g., the metal electrode) may be configured as a working electrode, a silver (Ag) or silver chloride (Ag/AgCl) electrode (or other standard electrode) may be configured as a reference electrode, and a platinum (Pt) foil or other standard electrode may be configured as a counter electrode. Such electrodes may be in any form, such as plate, foil, foam, or any three-dimensional (3D) structure. In some implementations, a distance between the electrode 102 and the counter electrode is between 1 nanometer (nm) and 10 centimeters (cm). The thickness of the 2D TMD material 104 layer(s) may be controlled by adjusting the coating (e.g., deposition) time, such as between 1 and 10,000 seconds, and by applying a bias (+/−) of approximately 0.1 to 10 volts. In implementations in which the electrode 102 includes a water-stable metal, the solution of the 2D TMD material 104 may include electrolytes dissolved in de-ionized (DI) water. In implementations in which the electrode 102 includes a water-unstable metal, the solution of the 2D TMD material 104 may include electrolytes dissolved in organic solvents such as dimethyl formamide (CH₃)₂NC(O)H, tetrahydrofuran (CH₂)₄O, ethylene carbonate (CH₂O)₂CO, acetonitrile (CH₃CN), tetraethylene glycol dimethylether (C₁₀H₂₂O₅), dioxolane (CH₂)₂O₂CH₂, dimethyl ether (CH₃OCH₃), or the like. In some implementations, a source of TMD material for use in creating the 2D TMD material 104 includes approximately 1 to 500 mM of ammonium tetrathiomolybdate ((NH₄)₂MoS₄), ammonium tetrathiotungstate ((NH₄)₂WS₄), ammonium orthothiovanadate ((NH₄)₃VS₄), ammonium orthothioniobate ((NH₄)₃NbS₄), ammonium orthothiotantalate (((NH₄)₃TaS₄), ammonium selenomolybdate ((NH₄)₂MoSe₄), ammonium selenotungstate ((NH₄)₂WSe₄), tetraethylammonium tetrathioperrhenate (NH₄ReS₄), ammonium tetra telluride molybdate ((NH₄)₂MoTe₄), or ammonium tetra telluride tungstate (NH₄)₂WTe₄ that is dissolved in an aqueous solvent or any other organic solvent and used as an electrolyte. After depositing the 2D TMD material 104, the TMD-coated electrode (e.g., the electrode 102 and the 2D TMD material 104) may be washed repeatedly with deionized (DI) water, ethanol, or an anhydrous solvent (e.g., ether) and dried under vacuum.

In some implementations, an optional interlayer may be disposed between the electrode 102 and the 2D TMD material 104. For example, if there are multiple layers of the 2D TMD material 104, the interlayer may be disposed between the electrode 102 and a first deposed layer of the 2D TMD material 104 (e.g., a bottom layer of the 2D TMD material 104 in the orientation shown in FIGS. 1A-B). The interlayer may include metal particles or one or more thin films of magnesium (Mg), silver (Ag), zinc (Zn), aluminum (Al), carbon (C), silicon (Si), tin (Sn), lead (Pb), antimony (Sb), bismuth (Bi), molybdenum (Mo), tellurium (Te), tantalum (Ta), titanium (Ti), or the like. The interlayer may provide additional protection for the electrode 102 or may promote adhesion of the 2D TMD material 104 to the electrode 102.

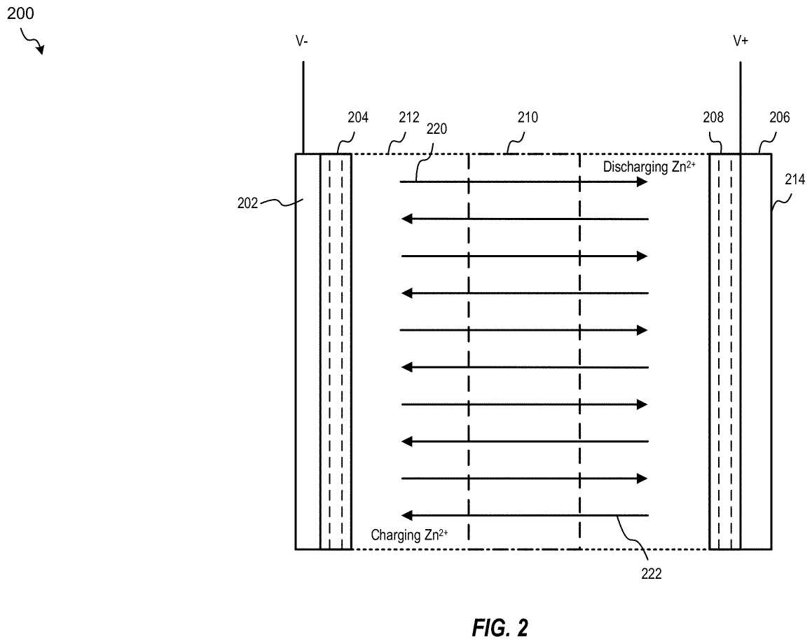

The electrochemical energy storage system 100 may further include a cathode and an electrolyte in direct contact with the anode (e.g., the electrode 102 and the 2D TMD material 104) and the cathode, which are not shown in FIGS. 1A-B. In some implementations, the cathode includes a second electrode formed from a carbon material and coated with one or more layers of manganese dioxide (including different phases such as α, β, γ, or δ-MnO₂) or other another material such as vanadium oxide. In some such implementations, the carbon material is carbon powder and carbon nanotube (CNT) paper, and the layer(s) of α-MnO₂ form nanorod structures (e.g., nanorods). Additional details of a battery are described herein with reference to FIG. 2.

As described above, the electrochemical energy storage system 100 provides benefits compared to conventional LIBs and other ZIBs. For example, due to the 2D TMD material 104 (e.g., MoS₂) coating acting as a protective layer for the electrode 102, dendrite growth is reduced or prevented on the electrode 102 (e.g., the zinc metal or other metal) due to the coating material's high ion transport and uniform deposition properties. Reducing or preventing dendrite growth on metal electrodes such as the electrode 102 reduces corrosion of the electrochemical energy storage system 100 and reduces or prevents safety issues at higher C-rates. Additionally, the orientation of the 2D TMD material 104 improves the flow of metal ions with a uniform electric field distribution on the electrode 102, resulting in uniform stripping and plating of metal ions. In addition, the coating of the 2D TMD material 104 enhances anodic diffusion of metal ions and reduces the series resistance of the electrochemical energy storage system 100, thereby improving the overall performance of the electrochemical energy storage system 100. The uniform stripping and plating of metal ions and enhanced anodic diffusion also improve the cycle life of the electrochemical energy storage system 100. Further, the electrochemical deposition process used to deposit the 2D TMD material 104 on the electrode 102 is less complex and highly scalable as compared to other anode formation techniques, thereby supporting relatively cost-effective manufacture of ZIBs (or other metal-ion batteries) having a long cycle life, excellent specific capacity, and improved safety as compared to conventional rechargeable batteries such as LIBs or other metal-ion batteries.

Referring to FIG. 2, an example of a battery system implemented with a 2D TMD material-coated metal anode according to one or more aspects is shown as a battery system 200. In some implementations, the battery system 200 may include or correspond to the electrochemical energy storage system 100 of FIG. 1. In the implementation illustrated in FIG. 2, the battery system 200 (e.g., a ZIB or other metal-ion battery) may include an electrode 202, a second electrode 206, a separator 210, an electrolyte 212, and a casing 214. The electrode 202 is a zinc electrode (e.g., includes metallic zinc or a zinc alloy) or another type of metal or metal alloy, such as aluminum, potassium, sodium, or the like. The electrode 202 may be coated with one or more layers of a 2D TMD material 204, such as a layer of MoS₂, WS₂, MoTe₂, MoSe₂, WSe₂, TiS₂, TaSe₂, NbSe₂, NiTe₂, BN, or the like, as non-limiting examples. The electrode 202 and the 2D TMD material 204 may operate as an anode of the battery system 200. The second electrode 206 is a carbon material. For example, the second electrode 206 may include CNT paper, activated carbon, porous carbon structures in 1D, 2D, or 3D structures, carbon powder, carbon fibers, carbon nanofibers, graphite, graphene, graphene oxides, or other materials suitable for operations described herein. The second electrode 206 may be coated with one or more layers of an electrode material 208 (e.g., an active material coating), such as α-MnO₂, another manganese oxide, or another material having suitable electrode properties (e.g., vanadium oxide (VO) as a non-limiting example). In some implementations, the layer(s) of α-MnO₂ may have a particular structure, such as one or more nanorods. The nanorod(s) may be oriented substantially perpendicular from the second electrode 206 (e.g., horizontally in the orientation shown in FIG. 2). In some such implementations, each nanorod has a diameter between 7 and 10 nm and a length between 1 and 1.5 micrometers (μm). The second electrode 206 and the electrode material 208 may operate as a cathode of the battery system 200.

During operation of the battery system 200, ion flow 220 illustrates the flow of discharging ions (e.g., Zn²⁺, etc. in implementations in which the anode is zinc or a zinc alloy) from the anode (e.g., the electrode 202 and the 2D TMD material 204), and ion flow 222 illustrates the flow of charging ions (e.g., Zn²⁺, etc.) from the cathode (e.g., the second electrode 206 and the electrode material 208). The separator 210 may be positioned between the anode and the cathode and may include, for example, polypropylene (PP), polyethylene (PE), other materials suitable for operations discussed herein, or combinations thereof. The separator 210 preferably has pores through which ion flows 220 and 222 may pass. As indicated by the dashed lines in FIG. 2, the separator 210 is optional and, in some other implementations, the battery system 200 does not include the separator 210. The electrolyte 212 may be positioned on either side of the separator 210, between the anode and the cathode, and may include any number of electrolyte solutions (e.g., aqueous, non-aqueous, etc.) which may allow for transporting ion flows 220 and 222 between the anode and the cathode. For example, the electrolyte 212 may include various aqueous electrolyte solutions, acidic electrolytes, zinc-based electrolytes (e.g., zinc sulfate (ZnSO₄), zinc chloride (ZnCl₂), or the like), or other electrolyte material suitable for operations discussed herein.

The electrode 202 (coated with the 2D TMD material 204) may operate as the anode, and the second electrode 206 (coated with the electrode material 208) may operate as the cathode of the battery system 200. In some implementations, the electrodes 202 and 206 may extend, through the casing 214, from an interior region of the casing 214 to an exterior region of the casing 214. Additionally, the electrodes 202 and 206 may correspond to/be coupled to negative and positive voltage terminals, respectively, of the battery system 200. The casing 214 may include a variety of cell form factors. For example, implementations of the battery system 200 may be incorporated in a cylindrical cell (e.g., 13650, 18650, 18500, 26650, 21700, etc.), a polymer cell, a button cell, a prismatic cell, a pouch cell, or other form factors suitable for operations discussed herein. Further, one or more cells may be combined into larger battery packs for use in a variety of applications (e.g., cars, laptops, etc.). In certain implementations, microcontrollers and/or other safety circuitry may be used along with voltage regulators to manage cell operation and may be tailored to specific uses of battery system 200.

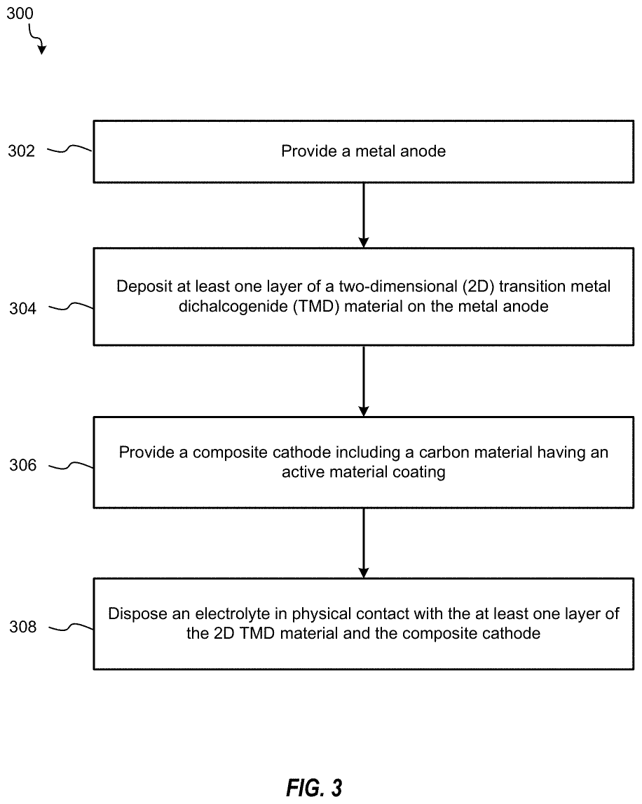

Referring to FIG. 3, a flow diagram of an example of a method for manufacturing a battery system with a 2D TMD material-coated metal anode according to one or more aspects is shown as a method 300. In some implementations, the operations of the method 300 may be stored as instructions that, when executed by one or more processors (e.g., one or more processors of a fabrication system), cause the one or more processors to perform the operations of the method 300. In some implementations, the method 300 may be performed to manufacture a ZIB or other metal-ion battery, such as the electrochemical energy storage system 100 of FIG. 1 or the battery system 200 of FIG. 2.

The method 300 includes providing a metal anode (such as zinc anode), at 302. For example, the metal anode may include or correspond to the electrode 102 of FIG. 1 or the electrode 202 of FIG. 2. The method 300 also includes depositing at least one layer of a 2D TMD material on the metal anode, at 304. For example, the 2D TMD material may include or correspond to the 2D TMD material 104 of FIG. 1 or the 2D TMD material 204 of FIG. 2.

In some implementations, the method 300 includes providing a composite cathode, at 306. The composite cathode may include a carbon material having an active material coating (such as α, β, γ, or δ-MnO₂, VO, or the like). For example, the cathode may include or correspond to the second electrode 206 of FIG. 2, and the MnO₂ coating (or other active material coating) may include or correspond to the electrode material 208 of FIG. 2. In some implementations, the method 300 further includes disposing an electrolyte in physical contact with the at least one layer of the 2D TMD material and the composite cathode, at 308. For example, the electrolyte may include or correspond to the electrolyte 212 of FIG. 2.

In some implementations, the 2D TMD material includes MoS₂. In some such implementations, each of the at least one layer of the 2D TMD material has a thickness between 1 and 100 nw, such as approximately 70 nm as a non-limiting example. Additionally or alternatively, each of the at least one layer of the 2D TMD material has a crystalline structure having a lattice spacing of approximately 0.625 nm. In some other implementations, the at least one layer of the 2D TMD material includes at least one layer selected from: molybdenum disulfide (MoS₂), tungsten disulfide (WS₂), molybdenum ditelluride (MoTe₂), molybdenum diselenide (MoSe₂), tungsten diselenide (WSe₂), titanium disulfide (TiS₂), tantalum disulfide (TaSe₂), niobium diselenide (NbSe₂), nickel ditelluride (NiTe₂), boron nitride (BN) (e.g., BN, c-BN, h-BN, etc.), molybdenum tungsten disulfide (MoWS₂), molybdenum tungsten ditelluride (MoWTe₂), molybdenum sulfur ditelluride (MoSTe₂), molybdenum sulfur diselenide (MoSSe₂), molybdenum rhenium disulfide (MoReS₂), niobium tungsten disulfide (NbWS₂), vanadium molybdenum ditelluride (VMoTe₂), tungsten sulfur diselenide (WSSe₂), tungsten tellurium disulfide (WTeS₂), boron carbon nitride (BCN), and tin selenium disulfide (SnSeS₂).

In some implementations, depositing the at least one layer of the 2D TMD material is performed by electrochemical deposition, as described above with reference to FIG. 1B. In some such implementations, the method 300 may further include controlling a deposition time of the electrochemical deposition to control a thickness of the at least one layer of the 2D TMD material. For example, the deposition time may be between 1 and 1000 seconds. Additionally or alternatively, the method 300 may also include controlling a bias voltage applied during the electrochemical deposition to control a thickness of the at least one layer of the 2D TMD material. For example, the bias voltage may be between 0.1 and 10 volts. Additionally or alternatively, the thickness of the at least one layer of the 2D TMD material may be between 1 nm and approximately 1000 nm. In some implementations, the electrochemical deposition is performed in an electroless, multiple electrode system. The electroless, multiple electrode system may include a working electrode, a reference electrode, and a counter electrode, as further described with reference to FIGS. 1A-1B. In some implementations, the working electrode includes the metal anode, the reference electrode includes a Ag/AgCl electrode, and the counter electrode includes a platinum foil.

In some implementations, the electrolyte includes an aqueous electrolyte solution. For example, the electrolyte 212 of FIG. 2 may include an aqueous zinc electrolyte solution, as a non-limiting example. Alternatively, the electrolyte may include a solid electrolyte solution.

In some implementations, the active material coating may include at least one layer of α-MnO₂. In some such implementations, the carbon material is CNT paper. For example, the second electrode 206 of FIG. 2 may include CNT paper or another carbon material, and the electrode material 208 of FIG. 2 may include one or more layers of MnO₂ (such as α, β, γ, and δ-MnO₂). Additionally or alternatively, the at least one layer of MnO₂ may include one or more nanorods. For example, the electrode material 208 of FIG. 2 may form one or more nanorods (e.g., nanorod structures). In some such implementations, the one or more nanorods each have a diameter between 7 and 10 nm and a length between 1 and 1.5 μm.

In some implementations, the metal anode includes a water-stable metal or metal alloy, and the 2D TMD material is deposited using a solution that includes electrolytes dissolved in DI water. In some other implementations, the metal anode includes a water-unstable metal, and the 2D TMD material is deposited using a solution that includes electrolytes dissolved in one or more of dimethyl formamide (CH₃)₂NC(O)H, tetrahydrofuran (CH₂)₄O, ethylene carbonate (CH₂O)₂CO, acetonitrile (CH₃CN), tetraethylene glycol dimethylether (C₁₀H₂₂O₅), dioxolane (CH₂)₂O₂CH₂, or dimethyl ether (CH₃OCH₃). Additionally or alternatively, the 2D TMD material is deposited from a source including ammonium tetrathiomolybdate ((NH₄)₂MoS₄), ammonium tetrathiotungstate ((NH₄)₂WS₄), ammonium orthothiovanadate ((NH₄)₃VS₄), ammonium orthothioniobate ((NH₄)₃NbS₄), ammonium orthothiotantalate (((NH₄)₃TaS₄), ammonium selenomolybdate ((NH₄)₂MoSe₄), ammonium selenotungstate ((NH₄)₂WSe₄), tetraethylammonium tetrathioperrhenate (NH₄ReS₄), ammonium tetra telluride molybdate ((NH₄)₂MoTe₄), or ammonium tetra telluride tungstate (NH₄)₂WTe₄.

As described above with reference to FIG. 3, the method 300 may enable manufacture of a battery (e.g., a rechargeable Zn-ion battery or other metal-ion battery) that includes a metal (e.g., Zn) anode coated with a 2D TMD material. Such a battery may experience reduced dendrite growth on the electrode and provide improved battery performance, such as enhanced cycle life, energy density, and capacity, as compared to LIB s or other metal-ion batteries.

### Experimental Testing of 2D TMD Material-Coated Zinc Anodes

The following describes experimental implementations of 2D TMD material-coated zinc anodes for use in Zn-ion batteries (ZIBs). The discussion further illustrates possible performance advantages afforded by the 2D TMD material-coated zinc anodes according to aspects described herein. It should be appreciated by those skilled in the art that the present disclosure is not intended to be limited to the particular experimental implementations described below.

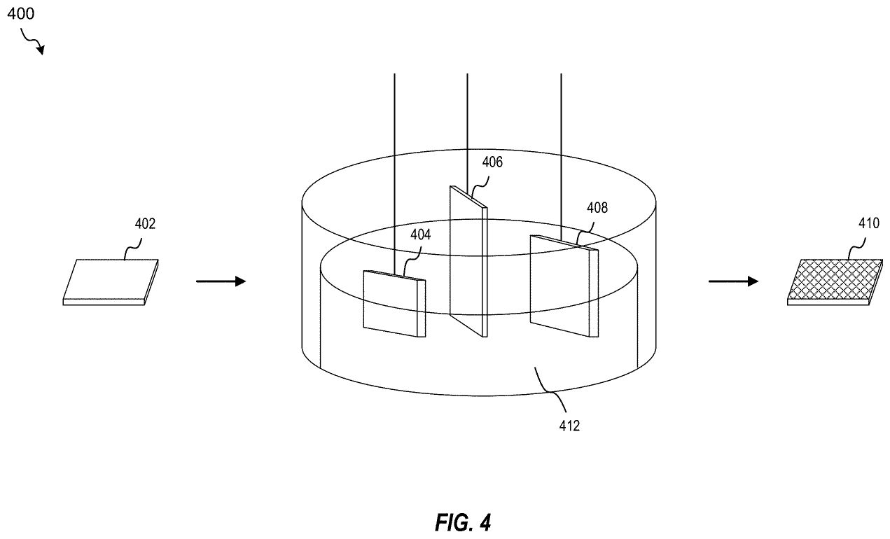

In an experimental implementation, a MoS₂ (e.g., corresponding to the 2D TMD material 104 of FIG. 1B) film was deposited on a Zn plate (e.g., corresponding to the electrode 102 of FIGS. 1A-B) using an electrochemical deposition technique in a three-electrode system, as shown as a system 400 in FIG. 4. In FIG. 4, a Zn foil 402 is used as a working electrode 404 in an electrodeposition process with a reference electrode 406 and a counter electrode 408 to form a 2D TMD-coated zinc anode 410 (e.g., a MoS₂-coated zinc foil). The Zn foil 402 was approximately 120 μm thick and cut in a size of 10×10 mm² to be used as the working electrode 404. A silver/silver chloride (Ag/AgCl) electrode and a platinum foil were used as the reference electrode 406 and the counter electrode 408, respectively, in the three-electrode system. Approximately 5 millimoles (mM) ammonium tetrathiomolybdate ((NH₄)MoS₄) was dissolved in deionized (DI) water and used as an electrolyte 412. A distance between the working electrode 404 (e.g., the Zn plate) and the counter electrode 408 was approximately 1.5 cm. The MoS₂ coating was deposited to each of five different Zn plates by applying −1 V for 0, 50, 100, 150, and 175 seconds, respectively. Each of the MoS₂-coated Zn plates were washed repeatedly with DI water/ethanol and dried at 60° C. under vacuum. These five fabricated MoS₂-coated Zn anodes were labeled as 0s-Zn, 50s-Zn, 100s-Zn, 150s-Zn, and 175s-Zn.

The α-MnO₂ nanorods (corresponding to the electrode material 208 of FIG. 2) were synthesized using the hydrothermal-coprecipitation method. First, manganese acetate (1.7 g, >95%) was dissolved in DI water (100 mL) followed by adding 50 mL of an aqueous solution of potassium manganate (KMnO₄) (0.75 g, >99%) under continuous stirring. The mixture was heated at 85° C. for 6 hours until most of the water had evaporated. The thick dark brown mixture was washed thoroughly using DI water and ethanol to remove all of the unwanted portions, including byproducts. The precipitates of α-MnO₂ nanorods were filtered using conventional filter paper (fine grade) and dried at 80° C. under vacuum for 24 hours.

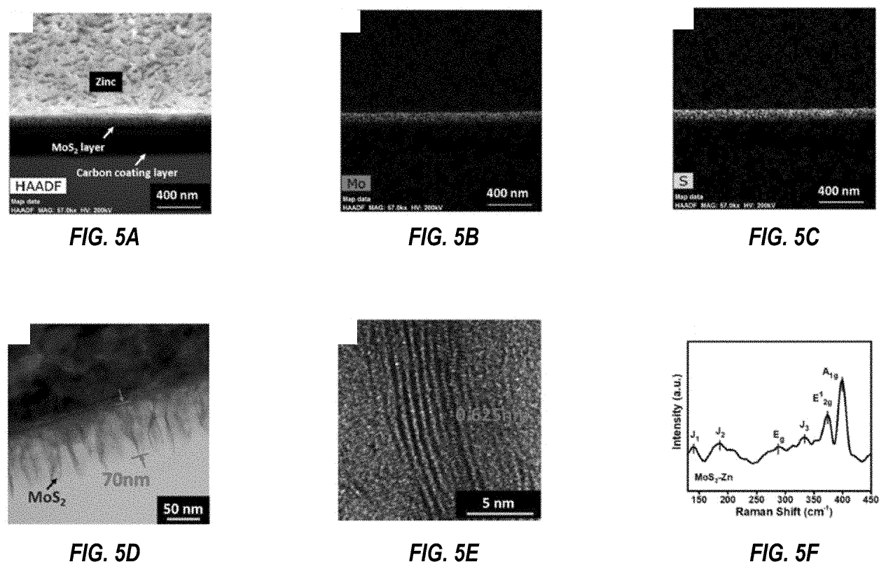

The synthesized MoS₂-coated Zn anodes and α-MnO₂-coated cathodes were characterized using a scanning electron microscope to obtain microstructural images of the samples. The transmission electron microscopy (TEM) images and the corresponding energy-dispersive X-ray (EDX) mapping images were acquired using a Talos F200X microscope equipped with an EDX analyzer at 200 kV, as shown in FIGS. 5A-5E. The MoS₂-coated Zn sample for TEM analysis was prepared by an in-situ lift-out technique via a focused ion beam (FIB) using a Quanta 3D FEG instrument, which is equipped with a field emission electron gun and a gallium liquid metal ion source. After depositing a protective layer (of tungsten) on the surface of the MoS₂-coated Zn bulk sample, FIB milling around the targeted area was applied by a Ga-ion beam with an image resolution of 7.0 nm for 2 hours at 23.0±2.0° C. Subsequently, an argon-milling device was used for the thinning of the MoS₂-coated Zn specimens to below 50 nm thickness. An omniprobe micromanipulator was used to control a tungsten needle for transferring the lift-out MoS₂-coated Zn specimens to a carbon-coated TEM grid. Also, a Pt-Gas Injection System was used to extract TEM specimens from selected locations. X-ray diffraction spectroscopy (XRD) was used to identify the phase and structural geometry of the α-MnO₂ samples. X-ray photoelectron spectroscopy (XPS) was used to confirm the bonding state and quantitative composition of the samples. The crystal structure of the MoS₂ coating on Zn was analyzed using Raman spectroscopy with an excitation wavelength of 532 nm, as shown in FIG. 5F.

The electronic conductivity of Zn anodes was measured using 4-probe station. Zn and Cu foils were used as a working and a counter electrode, respectively. The 1 M ZnSO₄/1 M MnSO₄ solution (pH<5.8) was used as an electrolyte throughout the study. The corrosion behavior was analyzed using a potentiodynamic polarization test using a 3-electrode workstation. The MoS₂-coated Zn foils were used as a working electrode, the Ag/AgCl electrode as a reference electrode, and the Zn plate as a counter electrode. Zn migration through the MoS₂ coatings was analyzed using a 3-electrode workstation. At this point, the MoS₂-coated Ti foil was used as a working electrode, the SCE electrode as a reference electrode, and the Zn plate as a counter electrode. The MoS₂ coating on Zn anodes was examined using the symmetric and full-cell analysis in CR2032 coin cells. Throughout the test, 30-40 μL of electrolytes composed of a 1 M ZnSO₄/1 M MnSO₄ solution was used. For the symmetrical cell test, Zn foil (1 cm² square section) was used as an anode and cathode separated using a conventional filter paper membrane. The full cell was fabricated using a MoS₂-coated Zn foil as an anode and α-MnO₂-coated CNT as a cathode. The cathode was fabricated by the conventional drop-casting method. For this a solution of α-MnO₂ (80 wt %), polyvinyl difluoride (10 wt %), and acetylene black (10 wt %) was dissolved in n-methyl-2-pyrrolidone and cast on the CNT paper (˜2 mg/cm²). The average weight of α-MnO₂ on CNT paper was observed to be around 3-4 mg/cm². All of the calculations were carried out by considering the active weight of α-MnO₂.

In this study, the MoS₂-coated Zn anode was fabricated using an electrochemical deposition technique (corresponding to FIG. 4). At −1.0 V vs Ag/AgCl, the (NH₄)₂MoS₄ in the aqueous solution (pH=˜6.2) starts to reduce on the Zn surface by forming MoS₄²⁻ ions, which further gets reduced to a uniform deposit of the MoS₂ film. At a low solution concentration of (NH₄)₂MoS₄ (5 mM), the reduction process of MoS₄²⁻ on the Zn surface can be controlled by an applied electric field. Here, vertically aligned MoS₂ layers under a high rate of MoS₂ growth conditions were synthesized. The thickness of the MoS₂ film was varied by changing the deposition time of the reduction process. As shown in FIG. 5A, the vertically aligned layers of the MoS₂ film were uniformly deposited on the surface of the Zn foil. The 150 second electrodeposition time was selected as an optimum time for uniform MoS₂ coating for this study. HRTEM analysis (FIGS. 5B and 5C) confirms the vertical structure of MoS₂ and uniform distribution of Mo and S elements with a 1:2 atomic composition of Mo:S with a film thickness of approximately 70 nm (FIG. 5D). It is evident that the layered sheets of MoS₂ exhibit a lattice spacing of 0.625 nm corresponding to the (002) plane (FIG. 5E). The crystalline structure of the MoS₂ coating was further confirmed using Raman spectroscopy (FIG. 5F). The MoS₂ peaks at 373.3 and 399.1 cm⁻¹ representing in-plane E¹_{2g} and out-of-plane A_{1g} phonon modes, respectively, and the gap between peaks of 25.8 cm⁻¹ represents few-layered MoS₂ sheets. In addition, peaks with lower intensities were observed near 140.2, 185.6, 287.5, and 333.7 cm⁻¹ corresponding to J₁, J₂, E_{g}, and J₃ peaks, respectively, indicating the 1 T phase of MoS₂.

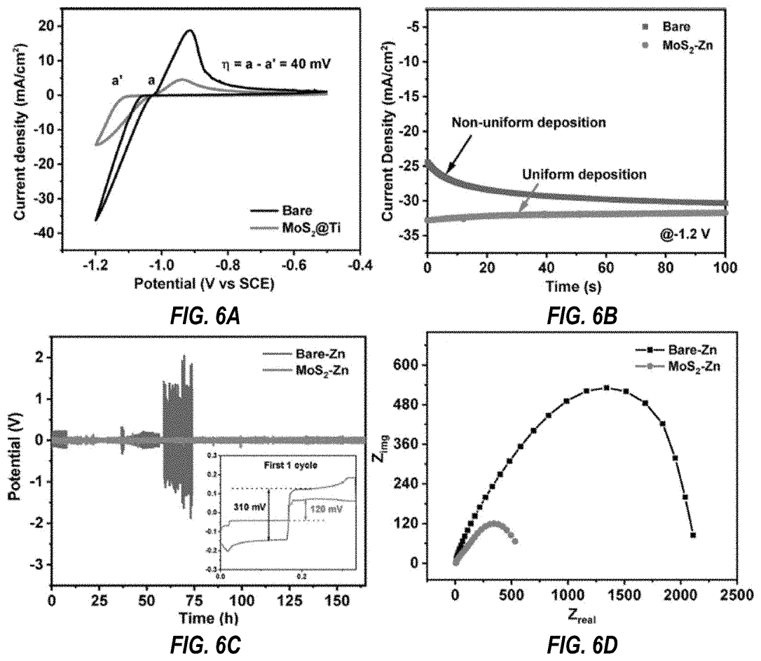

Electrochemical characterization of the MoS₂-coated Zn electrode was performed to study the electrodeposition behavior of Zn-ions during the charging and discharging cycles. A series of surface reactions, including nucleation and growth, occurs during the electrodeposition process; therefore, the final morphology of electrodeposited Zn depends upon its nucleation behavior on the electrode surface. To analyze this behavior, CV tests were performed (as shown in FIGS. 6A-6D) using a 3-electrode system where the MoS₂-coated Ti foil was used as a working electrode, the Zn plate as a counter electrode, and a saturated calomel electrode as a reference electrode. As exhibited in FIG. 6A, the crossover characteristics, known as the crossover potential of the nucleation activity, were observed at −1.027 V. The potential difference between point a and point a′ is termed as a nucleation overpotential (η). The relationship between the Zn nuclei radius and the nucleation overpotential is summarized by Equation 1 below.

$${r}_{c r i t} = 2 \frac{γ {V}_{m}}{F \vert η \vert} \qquad Equation 1$$

In Equation 1, γ is the surface energy of the interface between Zn and the electrolyte, Vₘ is the molar mass of Zn, F is the Faraday constant, and η is the nucleation overpotential. As compared to the bare-Ti foil, the MoS₂-coated Ti foil showed a 40 mV increase in the nucleation overpotential (α-α′). This increase in overpotential value results in Zn nucleation and growth with the finer nucleus, which alleviates the possibility for dendritic growth. The chronoamperometry test was performed by applying a potential of −1.2 V versus SCE reference using the MoS₂-coated Zn foils as working and counter electrodes to study the deposition behavior in detail (FIG. 6B). In the case of the bare-Zn electrodes, the gradual increase in the current-time behavior indicates eventual dendrite formation on the Zn surface. However, the MoS₂-coated Zn electrodes maintain a steady current-time behavior, showing a uniform deposition mechanism of Zn without any dendrite growth on the Zn surface. As an extended version of this test, a stability test of the MoS₂-coated Zn electrode was performed using a symmetrical cell test (FIG. 6C). The inset graph of FIG. 6C shows the first cycle of the symmetrical cell test with each step for the stripping and plating behavior. The difference between these two steps represents the overpotential for the stripping-plating reaction of Zn-ions. The MoS₂-coated Zn electrodes (120 mV) have a lower overpotential as compared to the bare-Zn electrodes (310 mV). Upon clear observation, the MoS₂-coated Zn electrodes maintain their stable deposition behavior, similar to FIG. 6B. This convention was further confirmed by the EIS test, where the MoS₂-coated Zn electrodes show reduced overall series resistance to allow faster deposition/extraction of the Zn-ions (FIG. 6D). Similar characteristics were previously observed in the report where MoS₂ allowed faster ion diffusion through the grain surface and prevented dendrite growth. SEM analysis after a symmetrical cell test confirmed that the bare-Zn electrodes show porous dendrite formation, resulting in eventual failure of the cell; however, the MoS₂-coated Zn electrodes remain stable and prevent dendrite growth even after 175 h of cycling. To further understand the stripping and plating behavior at higher current density, the symmetrical cell test was performed at a current density of 10 mA/cm² to obtain a capacity of 10 mAh/cm². Similar to the previous case, the symmetrical cell using bare Zn showed early failure during the first few cycles, while the MoS₂-coated Zn continued the performance for more than 120 h, suggesting that MoS₂ can serve as an efficient candidate to suppress dendrite growth and improve the Zn anode stability.

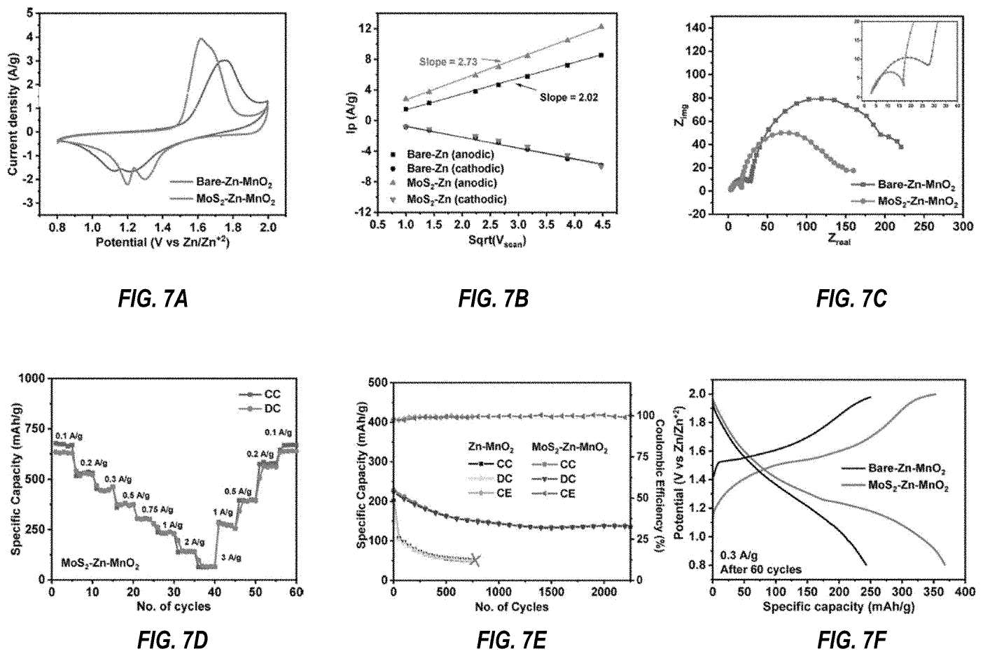

The full cell Zn//MnO₂ battery was fabricated using the MoS₂-coated Zn electrode as an anode and α-MnO₂-coated CNT paper as a cathode. The synthesized α-MnO₂ shows a nanorod shape with a diameter of 7-10 nm and a length of 1-1.5 Electrochemical analysis of a bare-Zn anode battery and the Zn//MnO₂ battery is shown in FIGS. 7A-7F. The charge storage mechanism of the Zn//MnO₂ battery was first analyzed using cyclic voltammetry (CV). As shown in FIG. 7A, the battery with a bare-Zn anode shows two distinct sets of oxidation and reduction peaks. By applying the MoS₂ coating on the Zn surface, the oxidation peak shifts slightly toward a lower potential, suggesting improved Zn²⁺ flow toward the anode surface while the reduction peak more evidently split into two distinct peaks corresponding to H⁺ and Zn²⁺ insertion in α-MnO₂ structure. To analyze its mechanism further, the anodic and cathodic diffusion coefficients of Zn were calculated using the classical Randles-Sevcik equation, shown in Equation 2 below.

Iₚ=2.69×10⁵n^{1.5}AD_{Zn}_{²⁺}^{0.5}C_{Zn}_{²⁺} Equation 2

In Equation 2, Iₚ is the peak current, n is the number of electrons in the reaction, D_{Zn}_{²⁺} is the diffusion coefficient, A is the area of the electrode, v is the scan rate, and C_{Zn}_{²⁺} is the Zn-ion concentration in an electrolyte. The relationship between the slope of the curves obtained by plotting the peak currents versus the square root of the scan rate provides the value for the Zn-ion diffusion coefficient (FIG. 7B). The anodic diffusion coefficients calculated for the bare and MoS₂-coated Zn anode were 7.04×10⁻⁶ and 1.28×10⁻⁵ cm²/s, respectively. It is clear that the MoS₂-coated Zn has higher ion conductivity than that of the bare-Zn, which is further confirmed by the lowered charge transfer resistance (R_{ct}, at a higher frequency) observed in the EIS spectrum (FIG. 7C). FIG. 7D shows the rate performance of the MoS₂—Zn//MnO₂ battery analyzed using the galvanostatic charge-discharge test at different ramping currents ranging from 0.1 to 3 A/g. At a current of 0.1 A/g, the exceptionally high specific capacity of −638 mAh/g was observed, which is greater than the theoretical specific capacity of the Zn—MnO₂ battery. This behavior was attributed to the contribution of mixed faradic and nonfaradic charge capacity as observed in pseudocapacitive cathode materials. Such performance improvement can be attributed to the high diffusivity of Zn²⁺ through the MoS₂-coated anode and MnO₂ cathode. The stability test performed using the MoS₂-coated Zn anode at 1 A/g shows stable performance for more than 2000 cycles with a final capacity retention of 143 mAh/g (FIG. 7E). The obtained high cycle stability can be attributed to the MoS₂ coating on the Zn anode, which effectively prevents dendrite growth. However, in the case of the bare-Zn//MnO₂ battery, the specific capacity was gradually decreased during the first 50 cycles, and the battery cell eventually failed after 748 cycles. A comparison of the galvanostatic curves for the bare and MoS₂—Zn//MnO₂ battery after 60 cycles is shown in FIG. 7F. As confirmed by the tests, the MoS₂ coating allows faster diffusion of Zn-ions toward the MnO₂ cathode, which increases the overall reactions occurring near the MnO₂ cathode and results in a higher discharge voltage and specific capacity in galvanostatic discharge curves of the MoS₂—Zn//MnO₂ battery. In the case of the bare Zn//MnO₂ battery, the higher interfacial resistance limits the flow of Zn-ions toward the MnO₂ cathode and has a lower discharge capacity. During charging, fast diffusion of Zn-ions has a lower voltage of the charging plateau for the MoS₂—Zn//MnO₂ battery and confirms that the MoS₂ coating allows faster Zn-ion diffusion during discharging as well as charging cycles.

To investigate the effectiveness of the MoS₂ coating against dendritic growth on Zn anodes, a Zn—MnO₂ battery was fabricated using a half MoS₂-coated Zn anode. For this process, only 50% of the Zn electrode was electrodeposited with MoS₂ using the electrodeposition process. The battery cells were cycled for 10 consecutive charge-discharge cycles at 0.3 A/g and dissembled for ex-situ analysis using SEM. The cross-sectional SEM images showed dendrite growth on the bare-Zn surface in addition to formation of cavities, while no dendrite growth was observed in the MoS₂-coated surface. This suggests that the MoS₂ coating can serve as an efficient passivation layer for preventing dendrite growth and cavity formation on the Zn anode during battery cycling.

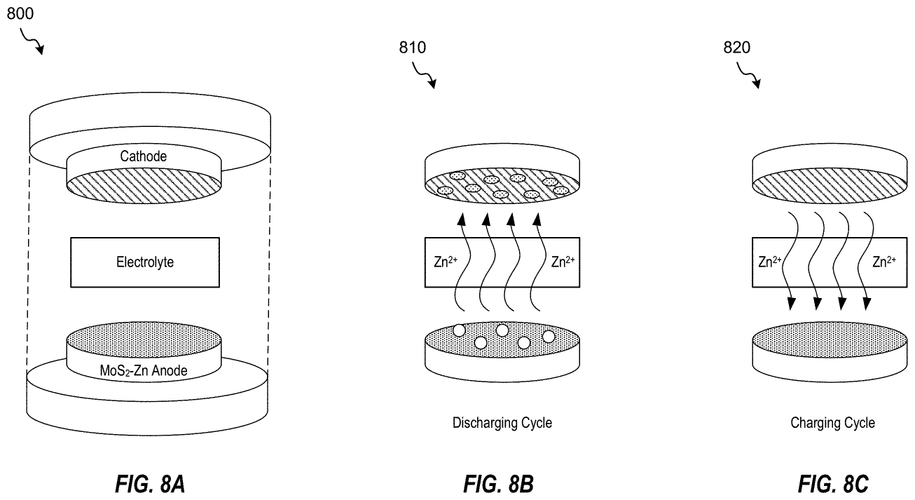

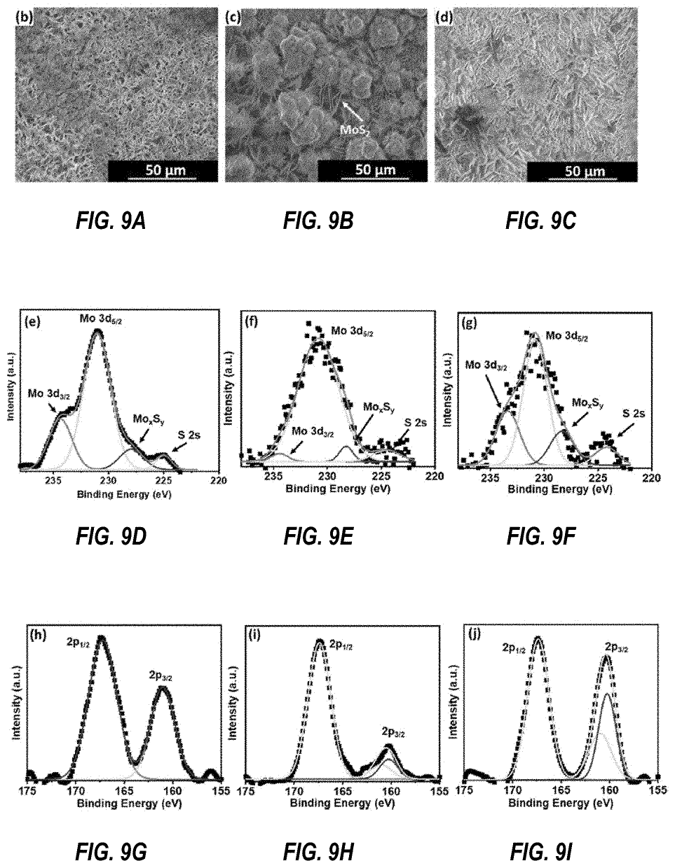

Surface analysis of the MoS₂—Zn anode after cycling was performed using XPS and SEM. FIGS. 8A-8C depict illustrative schematics of a test battery that includes the anode, and resultant SEM and XPS images are shown in FIGS. 9A-9I. The cell arrangement and the Zn-ion flow during the charging and discharging cycle is illustrated in FIGS. 8A-8C, with FIG. 8A illustrating a cell arrangement 800 during a reference state, FIG. 8B illustrating a cell arrangement 810 during a discharge cycle, and FIG. 8C illustrating a cell arrangement 820 during a charge cycle. SEM analysis of the MoS₂—Zn anodes after a reference state, the discharge (10th), and charge (11th) cycle shows the actual flow of Zn-ions through the MoS₂ layers (FIGS. 9A-9C). During discharge, Zn-ions flow through the MoS₂ layers and move toward the MnO₂ cathode, where the Zn-ion flow is limited by formation of ZnMn₂O₄ in the cathode. Since the Zn-ion diffusion is limited by the interface of MoS₂/electrolyte, the remaining Zn deposits can be observed on the MoS₂ coating after discharge (FIG. 9B). Upon charging, the Zn-ions move back to the MoS₂—Zn anode from the cathode. It is noted that the surface of MoS₂ is clean and recovers the pristine state, which confirms that the MoS₂ coating does not limit the ion transport; rather, it enhances the Zn-ion transport (FIG. 9C). This behavior was also confirmed by the EIS spectra, where the MoS₂ interfacial charge transfer resistance is reduced (FIG. 7C). To better understand the chemical nature of the MoS₂ coating during cycling, XPS analysis of the MoS₂—Zn anodes was performed. There are two major Mo 3 d (FIGS. 9D-9F) and S 2p (FIGS. 9G-9I) peaks of the XPS spectra to describe the chemical nature for the pristine and charge/discharge state of MoS₂ on the Zn anode. As shown in FIGS. 9E and 9F, the Mo 3 d states for the 10th discharge and the 11th charge MoS₂—Zn samples were observed at 234.72 and 233.38 eV (Mo 3 d_{3/2}), 230.84 and 230.85 eV (Mo 3 d_{5/2}), and 224.40 and 224.20 eV (S 2s), respectively; and the S 2p sulfur peaks (FIGS. 9H and 9I) are observed at 160.41 and 160.59 eV (S 2p_{3/2}) and 167.38 and 167.37 eV (S 2p_{1/2}), respectively. A small amount of nonstoichiometric MoₓS_{y} with an intermediate oxidation state was evident at a lower binding energy in the Mo 3 d state at 228.27 and 228.26 eV. It is noted that the Mo 3 d_{3/2} and S 2p_{3/2} peaks were significantly reduced, and the Mo 3 d_{5/2} peak was broadened, resulting in formation of a hydrated Zn—MoS₂ structure during the discharging cycle (FIG. 9B). A similar behavior was observed, where the flow of Zn²⁺ ions in MoS₂ nanosheets results in a broadening of the Mo 3 d peak during XPS analysis and forms a hydrated Zn—MoS₂ structure. It was analyzed that oxygen incorporation in the MoS₂ structure resulted in an increased interlayer spacing that made a significantly lower Zn²⁺ intercalation energy and facilitated Zn′-ion transfer kinetics in MoS₂ nanosheets. Li-ion transport in the MoS₂-coated Li anode had been investigated and it was found that the energy barrier for surface migration of Li-ions was much lower as compared to the bulk migration routes. It is expected that the MoS₂ surface would provide an easier route for Zn-ion transport; however, the detailed mechanism of Zn-ion flow in MoS₂ will be further investigated. After the discharging cycle, the MoS₂—Zn//MnO₂ battery was charged and a substantial recovery of the Mo 3 d and S 2p_{3/2} peaks close to the pristine state of the MoS₂—Zn anode was observed (FIGS. 9F and 9I). From the analysis, it is confirmed that Zn-ions can reversibly flow through the MoS₂ coating during the charging/discharging cycle to intercalate/deintercalate in the MnO₂ cathode. Enhanced flow of Zn-ions through the MoS₂ prevents dendrite growth and improves the overall life cycle of the Zn-ion batteries.

As described above, a unique 2D MoS₂ (e.g., 2D TMD material) coating on a Zn anode via an electrochemical deposition process is disclosed. The MoS₂ coating may be uniformly deposited on the Zn surface with a vertically aligned MoS₂ structure. The symmetrical cell fabricated using the MoS₂-coated Zn anode shows reduced polarization and enhanced flow of Zn-ions through the MoS₂ coating, which allows uniform stripping and plating of Zn²⁺ on the anode surface. The full cell MoS₂—Zn//MnO₂ battery shows an enhanced diffusion of Zn-ions and decreases the overall series resistance, which results in a superior specific capacity of 638 mAh/g at 0.1 A/g and excellent cycle stability over 2000 cycles without dendrite growth. The MoS₂ coating process is a facile, scalable, and promising technology and therefore paves an avenue for practical application of rechargeable Zn-ion batteries with a long life cycle and high safety.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method comprising:
providing a metal anode; and
depositing at least one layer of a two-dimensional (2D) transition metal dichalcogenide (TMD) material on the metal anode.

2. The method of claim 1, wherein the 2D TMD material comprises one or more of molybdenum disulfide (MoS₂), molybdenum diselenide (MoSe₂), tungsten disulfide (WS₂), tungsten diselenide (WSe₂), molybdenum tungsten disulfide (MoWS₂), molybdenum tungsten ditelluride (MoWTe₂), or cubic boron nitride (c-BN).

3. The method of claim 1, wherein depositing the at least one layer of the 2D TMD material is performed by electrochemical deposition.

4. The method of claim 3, further comprising controlling a deposition time of the electrochemical deposition to control a thickness of the at least one layer of the 2D TMD material.

5. The method of claim 4, wherein the deposition time is between 1 and 1000 seconds.

6. The method of claim 3, further comprising controlling a bias voltage applied during the electrochemical deposition to control a thickness of the at least one layer of the 2D TMD material.

7. The method of claim 6 wherein the bias voltage is between 0.1 and 10 volts.

8. The method of claim 3, wherein the electrochemical deposition is performed in an electroless, multiple electrode system.

9. The method of claim 8, wherein the electroless, multiple electrode system comprises a working electrode, a reference electrode, and a counter electrode, wherein the working electrode comprises the metal anode, wherein the reference electrode comprises a silver (Ag) or silver chloride (AgCl) electrode, and wherein the counter electrode comprises a platinum foil.

10. The method of claim 1, wherein the metal anode comprises a water-stable metal or metal alloy, and wherein the 2D TMD material is deposited using a solution that comprises electrolytes dissolved in de-ionized (DI) water.

11. The method of claim 1, wherein the metal anode comprises a water-unstable metal, and wherein the 2D TMD material is deposited using a solution that comprises electrolytes dissolved in one or more of dimethyl formamide (CH₃)₂NC(O)H, tetrahydrofuran (CH₂)₄O, ethylene carbonate (CH₂O)₂CO, acetonitrile (CH₃CN), tetraethylene glycol dimethylether (C₁₀H₂₂O₅), dioxolane (CH₂)₂O₂CH₂, or dimethyl ether (CH₃OCH₃).

12. The method of claim 1, wherein the 2D TMD material is deposited from a source comprising ammonium tetrathiomolybdate ((NH₄)₂MoS₄), ammonium tetrathiotungstate ((NH₄)₂WS₄), ammonium orthothiovanadate ((NH₄)₃VS₄), ammonium orthothioniobate ((NH₄)₃NbS₄), ammonium orthothiotantalate (((NH₄)₃TaS₄), ammonium selenomolybdate ((NH₄)₂MoSe₄), ammonium selenotungstate ((NH₄)₂WSe₄), tetraethylammonium tetrathioperrhenate (NH₄ReS₄), ammonium tetra telluride molybdate ((NH₄)₂MoTe₄), or ammonium tetra telluride tungstate (NH₄)₂WTe₄.

13. The method of claim 1, further comprising:
providing a composite cathode comprising a carbon material having a manganese dioxide (MnO₂) coating; and
disposing an aqueous electrolyte in physical contact with the at least one layer of the 2D TMD material and the composite cathode.

14. A battery comprising:
an anode comprising a metal electrode coated with at least one layer of a two-dimensional (2D) transition metal dichalcogenide (TMD) material;
a cathode; and
an electrolyte in direct contact with the anode and the cathode.

15. The battery of claim 14, wherein the metal electrode comprises zinc (Zn), aluminum (Al), magnesium (Mg), sodium (Na), potassium (K), lithium (Li), or an Li-alloy.

16. The battery of claim 14, wherein each of the at least one layer of the 2D TMD material has a thickness between 1 and 100 nanometers (nm).

17. The battery of claim 14, wherein the at least one layer of the 2D TMD material includes at least one layer selected from: molybdenum disulfide (MoS₂), tungsten disulfide (WS₂), molybdenum ditelluride (MoTe₂), molybdenum diselenide (MoSe₂), tungsten diselenide (WSe₂), titanium disulfide (TiS₂), tantalum disulfide (TaSe₂), niobium diselenide (NbSe₂), nickel ditelluride (NiTe₂), boron nitride (BN), molybdenum tungsten disulfide (MoWS₂), molybdenum tungsten ditelluride (MoWTe₂), molybdenum sulfur ditelluride (MoSTe₂), molybdenum sulfur diselenide (MoSSe₂), molybdenum rhenium disulfide (MoReS₂), niobium tungsten disulfide (NbWS₂), vanadium molybdenum ditelluride (VMoTe₂), tungsten sulfur diselenide (WSSe₂), tungsten tellurium disulfide (WTeS₂), boron carbon nitride (BCN), and tin selenium disulfide (SnSeS₂).

18. The battery of claim 14, wherein the cathode comprises a carbon material coated with at least one layer of an active material.

19. The battery of claim 18, wherein the carbon material is carbon nanotube (CNT) paper.

20. The battery of claim 18, wherein the at least one layer of active material comprises manganese dioxide (MnO₂) and includes one or more nanorods.
